(19) United States
(12) Patent Application Publication
(10) Pub. No.: US 2026/0320437 A1
(43) Pub. Date: Oct. 15, 2026

(54) INFORMATION PROCESSING DEVICE, INFORMATION PROCESSING METHOD, INFORMATION PROCESSING SYSTEM, AND NON-TRANSITORY COMPUTER-READABLE MEDIUM

(71) Applicant: NEC CORPORATION, Tokyo (JP)

(72) Inventors: Kei TAKEMURA, Tokyo (JP); Keita SAKUMA, Tokyo (JP)

(73) Assignee: NEC CORPORATION, Tokyo (JP)

(21) Appl. No.: 19/477,122

(22) PCT Filed: May 1, 2023
(86) PCT No.: PCT/JP2023/017066

§ 371 Date: Oct. 21, 2025

(51) Int. Cl. G06N 5/04; G06F 17/11

(52) U.S. Cl. CPC G06N 5/04; G06F 17/11

(57) ABSTRACT

In order to be able to provide optimization technology referencing output values from a plurality of models while suppressing calculation costs, this information processing device comprises: an acquisition unit for acquiring output values obtained from each of a plurality of models and loss values corresponding to each output value; a derivation unit for deriving a decision-making result according to each prediction value acquired by the acquisition unit and the reliability of each expert; and an updating unit for updating the reliability for each model by referring to each loss value acquired by the acquisition unit. The updating unit initializes, at mutually different timings, the reliability of each of a plurality of models constituting at least a part of the plurality of models.

### TECHNICAL FIELD

The present invention relates to an information processing device, an information processing method, an information processing system, and a program.

### BACKGROUND ART

There is known a sequential decision-making technology that sequentially repeats a process of deriving a prediction (decision-making result) regarding a demand, a supply, or the like, observing an execution result of the derived prediction, and deriving a further prediction based on the observation result.

For example, PTL 1 describes a configuration in which a technology for predicting traffic demand in a building includes a plurality of experts that predict a category of traffic demand with reference to different data included in a feature amount database and generate a prediction value, and one of the prediction values is adopted as a prediction result.

### CITATION LIST

### Patent Literature

PTL 1: JP 2014-172718 A

### SUMMARY OF INVENTION

### Technical Problem

As in PTL 1, a prediction technique that refers to prediction values from a plurality of experts has an advantage that prediction can be performed while suitably adapting to a changing environment, but an increase in calculation cost such as a calculation amount, a calculation time, and a memory capacity has been a problem.

An aspect of the present invention has been made in view of the above problems, and an object of the present invention is to provide an optimization technique that refers to output values from a plurality of experts (models) while suppressing a calculation cost.

### Solution to Problem

An information processing device according to one aspect of the present invention includes an acquisition means for acquiring an output value obtained from each of a plurality of models and a loss value relevant to each output value, a derivation means for deriving an optimal solution according to each output value acquired by the acquisition means and a reliability of each model, and an update means for updating the reliability of each model with reference to each loss value acquired by the acquisition means, in which the update means initializes the reliability of each of a plurality of models constituting at least a part of the plurality of models at different timings.

An information processing method according to one aspect of the present invention causes an information processing device to execute acquiring an output value obtained from each of a plurality of models and a loss value relevant to each output value, deriving an optimal solution according to the acquired each output value and a reliability of each model, and updating the reliability of each model with reference to the acquired each loss value, in which in the updating, the reliability of each of a plurality of models constituting at least a part of the plurality of models is initialized at different timings.

An information processing program according to one aspect of the present invention is a program for causing a computer to function as an information processing device, the program causing the computer to execute acquiring an output value obtained from each of a plurality of models and a loss value relevant to each output value, deriving an optimal solution according to the acquired each output value and a reliability of each model, and updating the reliability of each model with reference to the acquired each loss value, in which in the updating, the reliability of each of a plurality of models constituting at least a part of the plurality of models is initialized at different timings.

An information processing system according to one aspect of the present invention is an information processing system including an information processing device, and a terminal device, in which the information processing device includes an acquisition means for acquiring an output value obtained from each of a plurality of models and a loss value relevant to each output value, a derivation means for deriving an optimal solution according to each output value acquired by the acquisition means and a reliability of each model, and an update means for updating the reliability of each model with reference to each loss value acquired by the acquisition means, the update means initializes a reliability of each of a plurality of models constituting at least a part of the plurality of models at different timings, and the terminal device includes an execution means for executing an optimal solution derived by the information processing device, and a loss value acquisition means for acquiring a loss value obtained by executing the optimal solution.

### Advantageous Effects of Invention

According to one aspect of the present invention, it is possible to provide an optimization technique that refers to output values from a plurality of experts while suppressing calculation cost.

### BRIEF DESCRIPTION OF DRAWINGS

FIG. 1 is a block diagram illustrating a configuration of an information processing device according to a first exemplary example embodiment.

FIG. 2 is a flowchart illustrating a flow of an information processing method according to the first exemplary example embodiment.

FIG. 3 is a diagram for explaining processing by the information processing device according to the first exemplary example embodiment.

FIG. 4 is a block diagram illustrating a configuration of an information processing system according to the first exemplary example embodiment.

FIG. 5 is a flowchart illustrating a flow of processing by the information processing system according to the first exemplary example embodiment.

FIG. 6 is a block diagram illustrating a configuration of an information processing device according to a second exemplary example embodiment.

FIG. 7 is a diagram for explaining processing by the information processing device according to the second exemplary example embodiment.

FIG. 8 is a diagram for explaining processing by the information processing device according to an application example of the second exemplary example embodiment.

FIG. 9 is a diagram illustrating an example of information referred to by an information processing device according to an application example of the second exemplary example embodiment.

FIG. 10 is a block diagram illustrating a configuration of a computer that functions as the information processing device according to each exemplary example embodiment.

### EXAMPLE EMBODIMENT

### First Exemplary Example Embodiment

A first exemplary example embodiment of the present invention will be described in detail with reference to the drawings. The present exemplary example embodiment is a basic form of the exemplary example embodiment to be described later.

### <Outline of Information Processing Device 1>

An information processing device 1 according to the present exemplary example embodiment is an information processing device that acquires a prediction value from each of a plurality of experts and makes a decision using the plurality of acquired prediction values. The information processing device 1 according to the present exemplary example embodiment sequentially performs acquisition of a prediction value and decision-making. For example, in a round t, a prediction value P1t is acquired from an expert 1, a prediction value P2t is acquired from an expert 2, and a decision-making result (t) in the round t is derived with reference to the acquired prediction values P1t and P2t. Then, the information processing device 1 performs processing of updating a parameter for decision making, acquiring a prediction value in the next round, and deriving a decision-making result in the next round. t is an index representing the number of repetitions, and can also be interpreted as an index indicating timing.

In the present exemplary example embodiment, the “expert” may be specifically hardware such as a prediction value derivation device that outputs a prediction value, software such as a prediction value derivation algorithm that outputs a prediction value, or a living body (for example, a person) that outputs a prediction value by some method. The information processing device 1 according to the present exemplary example embodiment may be configured to include an “expert”, or may be configured to acquire a prediction value from an external “expert”. The “expert” is also referred to as a “model” or an “agent”.

In the present exemplary example embodiment, the “prediction value” may be, for example, a prediction value regarding demand or supply, or a prediction value related to another case (event). For example, the “prediction value” in the present exemplary example embodiment may be a prediction value regarding some parameter referred to by the information processing device 1. The information processing device 1 according to the present exemplary example embodiment can be applied to all processes of making a decision with reference to a prediction value from each of a plurality of experts regarding a target event.

In the present exemplary example embodiment, a case where the output value of the expert is a “prediction value” will be described, but the output value of the expert is not necessarily limited to the prediction value. The output value of the expert may be any value as long as the loss described later can be defined. For example, the output value of the expert may be output by a generation model or a control model.

In the present exemplary example embodiment, the “intention” refers to some information regarding a target event, and is not to be construed as being limited to an intention of a living body (person). For example, in an application scene of predicting a demand regarding a target product, a prediction value regarding a future demand is an example of an “intention” determined by the information processing device 1 according to the present exemplary example embodiment or an “decision-making result” derived by the information processing device 1. The information processing device 1 according to the present exemplary example embodiment can also be expressed as a decision-making device, a decision-making result deriving device, or the like. The “decision-making result” is also referred to as an “optimization solution” or an “optimization result”.

In the present exemplary example embodiment, the loss value is provided relevant to the prediction value provided by each of the plurality of experts. For example, a loss value L1 is provided relevant to a prediction value P1 provided by the expert 1, and a loss value L2 is provided relevant to a prediction value P2 provided by the expert 2. Each prediction value provided by the expert and the loss value relevant to each prediction value are acquired by the information processing device 1 and referred to in the decision-making processing or other information processing.

In the present exemplary example embodiment, the loss value may be expressed as a difference between the prediction value and the observed value (measured value) as an example, but this does not limit the present exemplary example embodiment. The loss value may be a difference between the prediction value and another predetermined value. The loss value may be an estimated value regarding the loss. The term “loss value” may include a concept of “reward”. For example, the loss value can also be expressed as a value obtained by inverting the sign of the reward value (a value obtained by multiplying the reward value by a negative constant). Therefore, the loss value according to the present exemplary example embodiment may be read as a reward value. The information referred to for calculating the loss value and the specific algorithm for calculating the loss value do not limit the present exemplary example embodiment.

### <Configuration of Information Processing Device 1>

Next, a configuration of the information processing device 1 will be described with reference to FIG. 1. FIG. 1 is a block diagram illustrating a configuration of the information processing device 1. As illustrated in FIG. 1, the information processing device 1 includes an acquisition unit 11 and a derivation unit 12.

### (Acquisition Unit 11)

The acquisition unit 11 acquires a prediction value obtained from each of a plurality of experts and a loss value relevant to each prediction value. Here, as described above, the “prediction value” may be, for example, a prediction value regarding demand or supply, or may be a prediction value regarding other cases (events). The “prediction value” may be a prediction value regarding some parameter referred to by the information processing device 1.

The “loss value relevant to each prediction value” refers to a loss value having some information-processing-related relationship with each prediction value. For example, the loss value L1 may indicate:
Difference between the prediction value P1 and the observed value; or
Difference between decision-making result derived by decision-making processing with reference to the prediction value P1 and the observed value. As described above, the concept of the loss value may include the concept of the reward value.

The acquisition unit 11 may acquire the prediction value and the loss value from the same acquisition source or from different acquisition sources. The acquisition unit 11 can be configured to acquire the prediction value and the loss value in the round for each round in the sequential decision-making processing, but this does not limit the present exemplary example embodiment.

### (Derivation Unit 12)

The derivation unit 12 performs:
a process of deriving a decision-making result according to each prediction value acquired by the acquisition unit 11 and the reliability of each expert; and
a process of updating the reliability of each expert with reference to each loss value acquired by the acquisition unit 11.

Here, the reliability is an index indicating how much the prediction value by each expert is reflected in the decision-making processing. The reliability may, by way of example, be expressed as a relative weight computed on the prediction value by each expert, but this does not limit the present exemplary example embodiment.

The derivation unit 12 resets the reliability of each of the plurality of experts constituting at least a part of the plurality of experts at different timings. For example, in a situation where the acquisition unit 11 acquires the prediction value P1 of the expert 1, the prediction value P2 of the expert 2, and the prediction value P3 of the expert 3, the derivation unit 12 resets a reliability w1 of the expert 1 and a reliability w2 of the expert 2 at different timings (rounds). Here, “reset” refers to, as an example, a process of setting the target reliability to 0, but this does not limit the present exemplary example embodiment. The process “reset” may be any process to set the target reliability to a predetermined value. “Reset” is also referred to as “initialization”. The derivation unit 12 according to the present example embodiment is an example of “derivation means” and “update means” in the claims.

As described above, the information processing device 1 according to the present exemplary example embodiment derives the decision-making result (optimal solution) according to the prediction value (output value) provided by each of the plurality of experts (models) and the reliability of each of the experts (models), and resets the reliability of each of the plurality of experts (models) constituting at least a part of the plurality of experts (models) at different timings (rounds). As described above, since the information processing device 1 according to the present exemplary example embodiment resets the reliability of each of the plurality of experts (models) constituting at least a part of the plurality of experts (models) at different timings, it is possible to suppress an increase in calculation cost while suppressing a decrease in accuracy of a decision-making result (optimal solution).

### <Flow of Information Processing Method S1>

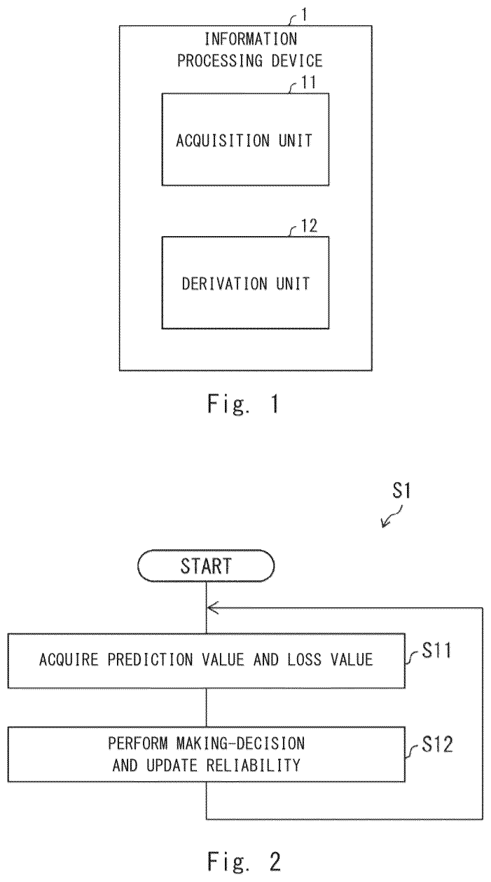

Next, a flow of an information processing method S1 according to the present first exemplary example embodiment will be described with reference to FIG. 2. FIG. 2 is a flowchart illustrating the flow of the information processing method S1.

### (Step S11)

In step S11, the acquisition unit 11 acquires a prediction value obtained from each of a plurality of experts and a loss value relevant to each prediction value.

### (Step S12)

In step S12, the derivation unit 12 performs:
a process of deriving a decision-making result according to each prediction value acquired by the acquisition unit 11 and the reliability of each expert; and
a process of updating the reliability of each expert with reference to each loss value acquired by the acquisition unit 11.

In step S12, the derivation unit 12 resets the reliability of each of the plurality of experts constituting at least a part of the plurality of experts at different timings.

In other words, the derivation unit 12 resets the reliability of a certain expert in step S12 in a certain round, and resets the reliability of another expert in step S12 in another round.

The information processing device 1 performs the processes of steps S11 and S12 in a certain round and then performs the processes of steps S11 and S12 in the next round.

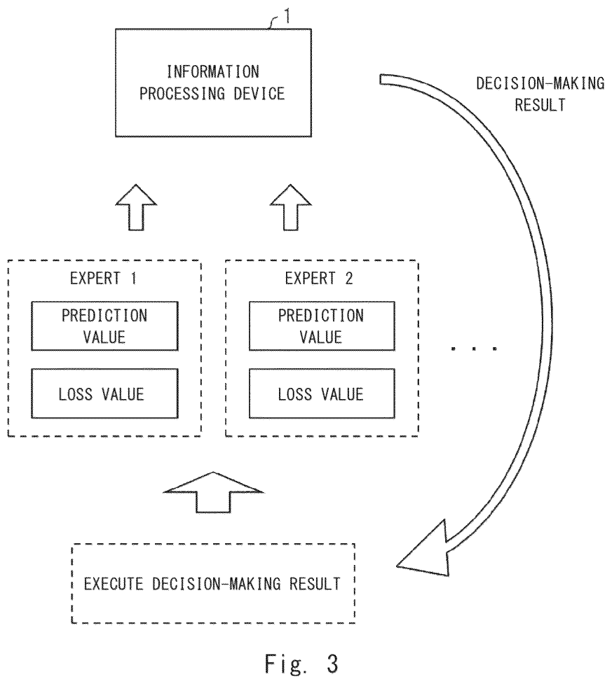

FIG. 3 is a diagram for schematically explaining sequential decision-making processing by the information processing method S1 according to the present exemplary example embodiment. As illustrated in FIG. 3, the information processing device 1 acquires a prediction value and a loss value associated with each expert for a plurality of experts in a certain round. Then, the decision-making result is derived with reference to the acquired prediction values and loss values. Then, a loss value relevant to the next round is obtained by executing the derived decision-making result. The loss value and the prediction value relevant to the loss value are provided to the information processing device 1, and are referred to in the decision-making processing in the next round. In this manner, the information processing device 1 sequentially derives the decision-making result.

As described above, in the information processing method S1 according to the present exemplary example embodiment, the decision-making result (optimal solution) is derived according to the prediction value (output value) provided by each of the plurality of experts (models) and the reliability of each of the experts (models), and the reliability of each of the plurality of experts (models) constituting at least a part of the plurality of experts (models) are reset at different timings (rounds). As described above, since the information processing device 1 according to the present exemplary example embodiment resets the reliability of each of the plurality of experts (models) constituting at least a part of the plurality of experts (models) at different timings, it is possible to suppress an increase in calculation cost while suppressing a decrease in accuracy of a decision-making result (optimal solution).

### <Configuration of Information Processing System 100>

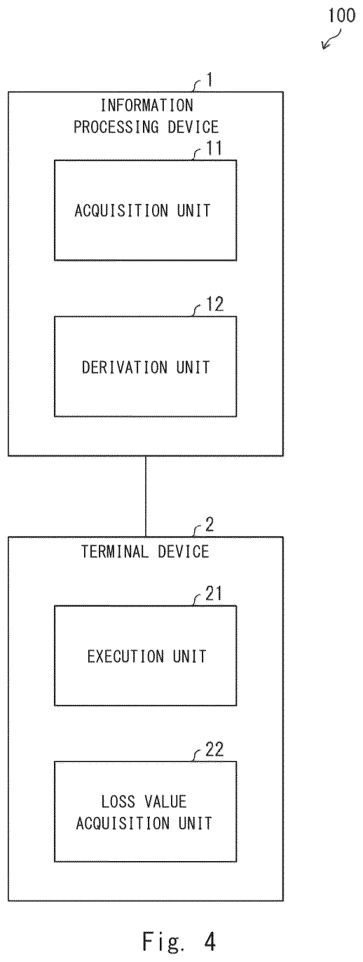

Next, a configuration of an information processing system 100 according to the present exemplary example embodiment will be described with reference to FIG. 4. FIG. 4 is a block diagram illustrating the configuration of the information processing system 100. As illustrated in FIG. 4, the information processing device 100 includes an information processing device 1 and a terminal device 2 communicably connected to each other. Since each configuration included in the information processing device 1 has been described above, description thereof is omitted here.

### (Terminal Device 2)

As illustrated in FIG. 4, the terminal device 2 includes an execution unit 21 and a loss value acquisition unit 22. The execution unit 21 executes a decision-making result derived by the information processing device 1 or processing relevant to the decision-making result. As an example, in a case where the decision-making result is to predict X pieces as today's demand regarding a product A, the execution unit 21 places an order for X pieces of the product A.

The loss value acquisition unit 22 acquires a loss value relevant to each of the prediction values of the plurality of experts referred to by the information processing device 1. As an example, the loss value acquisition unit 22 performs:
acquiring, as a loss L1, a difference between a prediction value P1 of today's demand for a product A and a quantity of the products A sold today, the prediction value P1 being provided by the expert 1; and
acquiring, as a loss L1, a difference between a prediction value P2 of today's demand for the product A and a quantity of the products A sold today, the prediction value P2 being provided by the expert 2.

The acquired loss value is referred to in the update processing of the reliability of each expert in the next round (in the case of the present example, tomorrow) in the information processing device 1.

### <Flow of Information Processing Method S100>

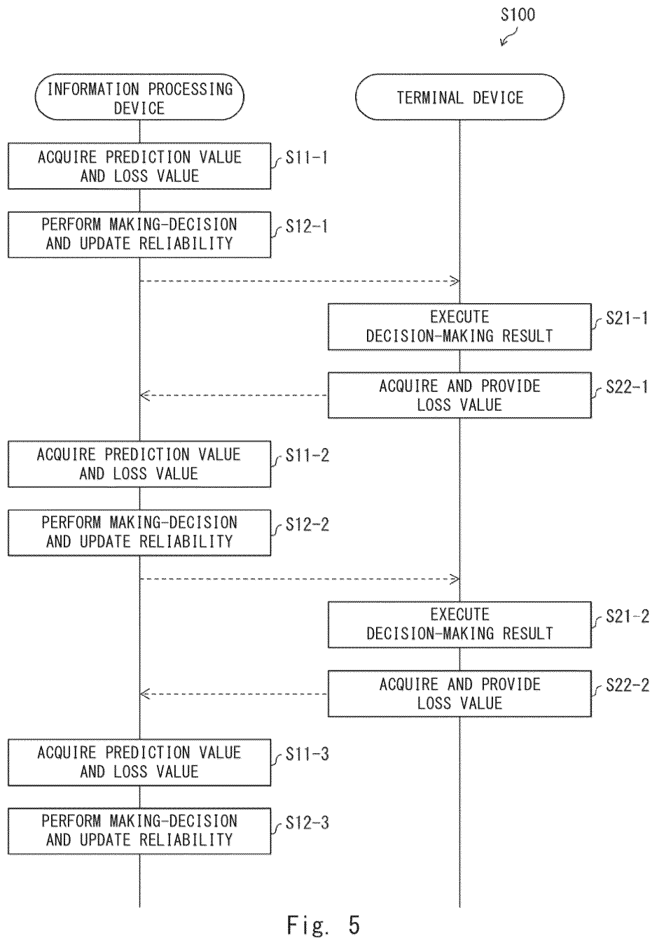

Next, a flow of an information processing method S100 according to the present first exemplary example embodiment will be described with reference to FIG. 5. FIG. 5 is a flowchart illustrating a flow of the information processing method S100 executed by the information processing system 100.

### (Steps S11-1 and S12-1)

As illustrated in FIG. 4, in step S11-1, the acquisition unit 11 acquires a prediction value regarding the round (round t=1) obtained from each of a plurality of experts and a loss value relevant to each prediction value.

In step S12-1, the derivation unit 12 performs:
a process of deriving a decision-making result according to each prediction value acquired in step S11-1 by the acquisition unit 11 and the reliability of each expert; and
a process of updating the reliability of each expert with reference to each loss value acquired in step S12-1 by the acquisition unit 11. The decision-making result derived in step S12-1 is provided to the terminal device 2.

In step S12-1, the derivation unit 12 resets the reliability of each of the plurality of experts constituting at least a part of the plurality of experts at different timings.

In other words, the derivation unit 12 resets the reliability of a certain expert (for example, the expert 1) and does not reset the reliability of another expert (for example, the experts 2 and 3) in step S12-1 in the round.

### (Steps S21-1 and S22-1)

In step S21-1, the execution unit 21 of the terminal device 2 executes the decision-making result determined in step S12-1 or processing relevant to the decision-making result. In step S22-1, the loss value acquisition unit 22 of the terminal device 2 acquires a loss value obtained as a result of the execution and provides the loss value to the information processing device 1.

### (Steps S11-2 and S12-2)

In step S11-2, the acquisition unit 11 acquires a prediction value regarding the round (round t=2) obtained from each of a plurality of experts and a loss value relevant to each prediction value. Here, each prediction value is, for example, the loss value acquired by the loss value acquisition unit 22 in step S22-1.

In step S12-2, the derivation unit 12 performs:
a process of deriving a decision-making result according to each prediction value acquired in step S11-2 by the acquisition unit 11 and the reliability of each expert; and
a process of updating the reliability of each expert with reference to each loss value acquired in step S11-2 by the acquisition unit 11. The decision-making result derived in step S12-2 is provided to the terminal device 2 and executed in step S21-2.

In step S12-2, the derivation unit 12 resets the reliability of each of the plurality of experts constituting at least a part of the plurality of experts at different timings.

In other words, the derivation unit 12 resets the reliability of a certain expert (for example, the expert 2) and does not reset the reliability of other experts (for example, the experts 1 and 3) in step S12-2 in the round.

As described above, in the information processing method S100 according to the present exemplary example embodiment, the decision-making result (optimal solution) is derived according to the prediction value (output value) provided by each of the plurality of experts (models) and the reliability of each of the experts (models), and the reliabilities of the plurality of experts (models) constituting at least a part of the plurality of experts (models) are reset at different timings (rounds). As described above, since the information processing system 100 according to the present exemplary example embodiment resets the reliability of each of the plurality of experts (models) constituting at least a part of the plurality of experts (models) at different timings, it is possible to suppress an increase in calculation cost while suppressing a decrease in accuracy of a decision-making result (optimal solution).

### Second Exemplary Example Embodiment

A second exemplary example embodiment of the present invention will be described in detail with reference to the drawings. Components having the same functions as the components described in the first exemplary example embodiment are denoted by the same reference signs, and the description thereof will be appropriately omitted.

### <Configuration of Information Processing System 100A>

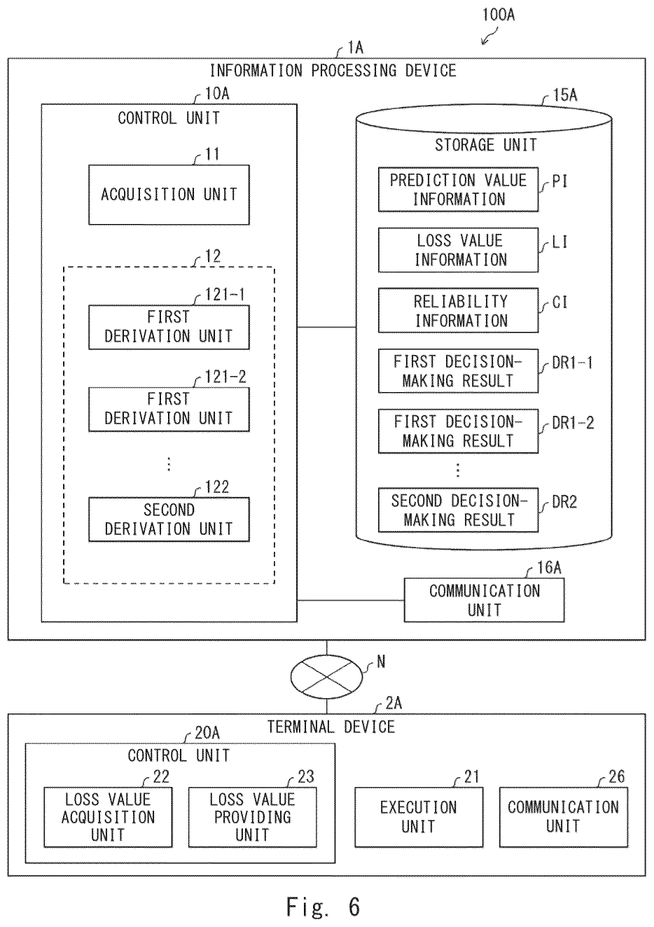

A configuration of an information processing system 100A according to the present exemplary example embodiment will be described with reference to FIG. 6. FIG. 6 is a block diagram illustrating a configuration of the information processing system 100A. As illustrated in FIG. 6, the information processing system 100A includes an information processing device 1A and a terminal device 2A. As illustrated in FIG. 6, the information processing device 1A and the terminal device 2A are configured to be communicable via a network N. Here, the specific configuration of the network N is not limited to the present exemplary example embodiment, but as an example, a wireless local area network (LAN), a wired LAN, a wide area network (WAN), a public line network, a mobile data communication network, or a combination of these networks can be used.

### <Configuration of Information Processing Device 1A>

A configuration of an information processing device 1A according to the present exemplary example embodiment will be described with reference to FIG. 6. FIG. 6 is a block diagram illustrating the configuration of the information processing device 1A.

As illustrated in FIG. 6, the information processing device 1A includes a control unit 10A, a storage unit 15A, and a communication unit 16A.

The communication unit 16A communicates with a device outside the information processing device 1A. As an example, the communication unit 16A communicates with the terminal device 2A. The communication unit 16A transmits data supplied from the control unit 10A to the terminal device 2A, and supplies data received from the terminal device 2A to the control unit 10A.

### (Storage Unit 15A)

The storage unit 15A stores various types of information referred to by the control unit 10A and various types of information derived by the control unit 10A. As an example, the storage unit 15A stores:
prediction value information PI including a prediction value by each of a plurality of experts;
loss value information LI including loss value relevant to prediction value by each of the plurality of experts;
reliability information CI including the reliability of each of a plurality of experts;
first decision-making results DR1-1, DR1-2, . . . derived by each of a plurality of first derivation units 121-1, 121-2, . . . to be described later; and second decision-making result DR2 derived by second derivation unit 122 to be described later.

As described in the first exemplary example embodiment, the information processing system 100A according to the present exemplary example embodiment may be configured to include an “expert” or may be configured to acquire a prediction value from an “expert” outside the system.

### (Control Unit 10A)

As illustrated in FIG. 6, the control unit 10A includes the acquisition unit 11, and the derivation unit 12.

### (Acquisition Unit 11)

Similarly to the first exemplary example embodiment, the acquisition unit 11 acquires a prediction value obtained from each of a plurality of experts and a loss value relevant to each prediction value. Since the prediction value and the loss value have been described in the first exemplary example embodiment, the same description will be omitted. Specific examples of the prediction value and the loss value will be described later.

### (Derivation Unit 12)

Similarly to the first exemplary example embodiment, the derivation unit 12 performs:
a process of deriving a decision-making result according to each prediction value acquired by the acquisition unit 11 and the reliability of each expert; and
a process of updating the reliability of each expert with reference to each loss value acquired by the acquisition unit 11.

Here, since the reliability has been described in the first exemplary example embodiment, the same description will be omitted. A specific example of the reliability will be described later.

The derivation unit 12 may derive the decision-making result with further reference to a parameter for correcting the reliability. According to this configuration, the reliability of each expert can be appropriately corrected by the parameter, so that the information processing device 1 can be operated with guaranteed minimum accuracy, that is, can be operated in a so-called conservative manner.

Similarly to the first exemplary example embodiment, the derivation unit 12 resets the reliability of each of a plurality of experts constituting at least a part of the plurality of experts at different timings.

As an example, the derivation unit 12 may be configured to reset the reliability wₙ of the n-th expert among the plurality of experts using a predetermined proportionality coefficient d (d is a natural number) and a constant term g (g is an integer) at timings (rounds) t expressed as follows:

$$t = d \times {2}^{n} + g$$

(Here, symbol × represents an arithmetic symbol representing a product. The same applies hereinafter).

As another example, the derivation unit 12 may be configured to reset the reliability wₙ of the n-th expert among the plurality of experts using the total number N of experts and predetermined constants d (d is a natural number) and g (g is an integer) at timings (rounds) t expressed as follows:

$$t = d \times N + n + g .$$

As described above, since the information processing system 100A according to the present exemplary example embodiment resets the reliability of each of the plurality of experts constituting at least a part of the plurality of experts at different timings, it is possible to suppress an increase in calculation cost while suppressing a decrease in accuracy of a decision-making result.

As illustrated in FIG. 6, the derivation unit 12 according to the present exemplary example embodiment includes a plurality of first derivation units 12-1, 121-2, . . . , and a second derivation unit 122.

Here, in the round t, each first derivation unit 121-j (j is an index for identifying the first derivation unit from each other) derives the first decision-making result (pₜ(j)) according to each prediction value (mₜ) acquired by the acquisition unit 11 and the reliability (wlₜ) of each expert, and updates the reliability (wlₜ) regarding each expert with reference to each loss value (lₜ) acquired by the acquisition unit 11 (deriving wlₜ₊₁). In the expression in parentheses, an index for identifying each expert from each other is omitted.

The second derivation unit 122 derives the second decision-making result according to the first decision-making result (pₜ(j)) derived by each of the plurality of first derivation units 121-1, 121-2, . . . and the reliability (w2ₜ(j)) of each of the plurality of first derivation means.

The derivation unit 12 according to the present exemplary example embodiment executes the hierarchical decision-making processing as described above as an example by the plurality of first derivation units 12-1, 121-2, . . . , and the second derivation unit 122, but this does not limit the present exemplary example embodiment.

### <Configuration of Terminal Device 2A>

As illustrated in FIG. 6, the terminal device 2A includes a control unit 20A, an execution unit 21, and a communication unit 26. As an example, the terminal device 2A can be specifically implemented as an accounting terminal arranged in a store, an inventory management terminal arranged in a warehouse, and the like, but this does not limit the present exemplary example embodiment.

The communication unit 26 communicates with a device outside the terminal device 2A. As an example, the communication unit 26 communicates with the information processing device TA. The communication unit 26 transmits data supplied from the control unit 20A to the information processing device TA, and supplies data received from the information processing device TA to the control unit 20A.

The execution unit 21 performs processing relevant to the decision-making result derived by the derivation unit 12 or the decision-making result. As an example, the execution unit 21 executes the second decision-making result derived by the derivation unit 12. The execution unit 21 may be configured to execute at least a part of the plurality of first decision-making results derived by the derivation unit 12 instead of or in addition to the second decision-making results derived by the derivation unit 12.

As illustrated in FIG. 6, the control unit 20A includes a loss value acquisition unit 22 and a loss value providing unit 23. The loss value acquisition unit 22 acquires a loss value regarding each expert obtained as a result of execution by the execution unit 21. The loss value providing unit 23 provides the loss value acquired by the loss value acquisition unit 22 to the information processing device TA via the communication unit 26.

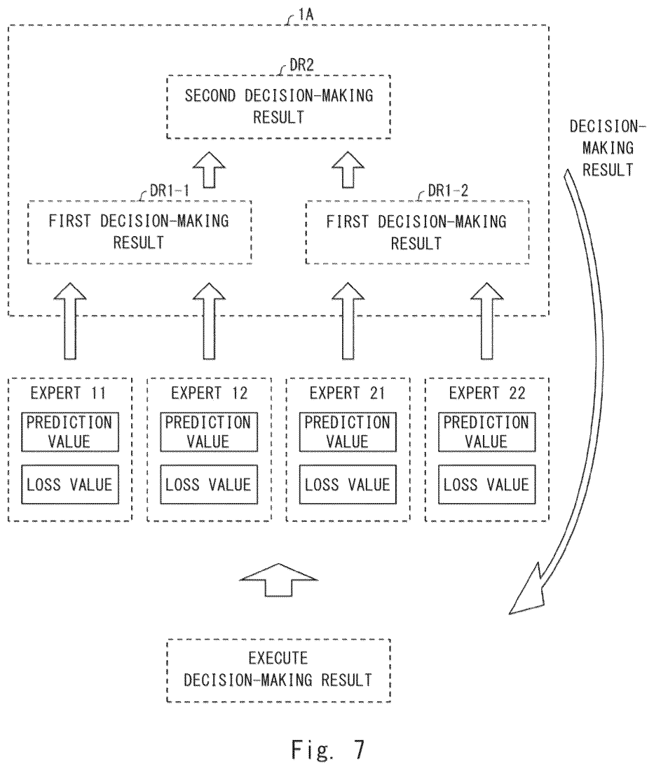

FIG. 7 is a diagram for schematically explaining sequential decision-making processing by the information processing system 100A according to the present exemplary example embodiment. As illustrated in FIG. 7, the information processing device TA acquires a prediction value and a loss value associated with each expert for a plurality of experts in a certain round, and derives a decision-making result with reference to each acquired prediction value and each acquired loss value. Here, as an example, the decision-making processing performed by the information processing device TA is hierarchical decision-making processing performed by the plurality of first derivation units 12-1, 121-2, . . . , and the second derivation unit 122 as described above.

Then, a loss value relevant to the next round is obtained by executing the derived decision-making result. The loss value and the prediction value relevant to the loss value are provided to the information processing device TA, and are referred to in the decision-making processing in the next round. In this manner, the information processing system 100A sequentially derives the decision-making result.

### (First Specific Processing Example by Information Processing Device 1A)

Hereinafter, a first specific processing example of the information processing device TA will be described. The information processing device TA according to the present example executes the following Algorithm 1 and Algorithm 2. Algorithm 1 is mainly executed by each of the plurality of first derivation units 121-1, 121-2, . . . , and Algorithm 2 is mainly executed by the second derivation unit 122.

MATH 1
Algorithm 1

```
Input: K ∈ [symbol] , N ∈ [symbol]   and η ∈ [symbol]   s.t. η > 0.
  1: w₁ ← 0_{K×N}.
  2: for t = 1, 2, ... T do
  3: Receive prediction mₜ ∈ [symbol] ^{K}.
  4: \tilde{w}ₜ(i, n) ← exp (−η(wₜ(i, n) + mₜ(i))) for all i ∈ [K] and n ∈ [N].
  5:  $p \text{?} ( i ) ← \frac{\text{?}}{\text{?}} for all i ∈ [ K ] .$
  6: Play pₜ ∈ Δ_{K} and observe [symbol] [symbol]     ∈ [symbol] ^{K}.
  7: Receive αₜ ∈ [symbol]  .
  8: for n ∈ [N] do
  9: if t = d2ⁿ for some odd integer d then
10: wₜ₊₁(i, n) ← 0 for all i ∈ [K].
11: else
12: wₜ₊₁(i, n) ← wₜ(i, n) + [symbol]  ₜ(i) − ( [symbol]  ₜ, pₜ) + [symbol] η( [symbol]  ₜ(i) − mₜ(i) + αₜ)² for all i ∈ [K]. [symbol]
indicates data missing or illegible when filed
```

MATH 2
Algorithm 2

```
Input: K ∈ [symbol] , N ∈ [symbol] , T ∈ [symbol] , and a base algorithm [symbol]  .
  1: Let M = [log [symbol]   T] and η(j) = 2^{j-M/2} for all j ∈ [M].
  2. Let w [symbol]  ∈ Δ [symbol]   such that p′₁ ∝ η(j)² for each j ∈ [M].
  3: Initialize base algorithms ( [symbol]  ⱼ )_{j∈[M]}, where [symbol]  ⱼ = [symbol]  (K, N, T, η(j)).
  4: for t = 1, 2, ... , T do
  5: Receive prediction mₜ ∈ [symbol] ^{K} and feed it to all base algorithms.
  6: Receive decision p_{t,j}, ∈ [symbol] ^{K} and define h [symbol]  (j) = (mₜ, p_{t,j}).
  7:  $\text{?} ∈ arg min \text{?} \{ 〈 \text{?} , w 〉 + {D}_{\text{?}} ( w , w \text{?} ) \} , where ψ ( w ) = {\sum }_{j ∈ [ M ]} \frac{1}{\text{?}} w ( j ) log w ( j ) .$
  8: pₜ ← Σ_{j∈[M]} wₜ(j)p_{t,j}.
  9: Play pᵢ ∈ Δ_{K} and observe [symbol]  ₜ ∈ [symbol] ^{K}.
10: Receive αₜ ∈ [symbol] ^{M}.
11: Feed [symbol]  ₜ and αₜ(j) to [symbol]  ⱼ for each j ∈ [M].
12. Receive βₜ ∈ [symbol] .
13:  ${w}_{t + 1}^{′} ∈ arg min \text{?} \{ 〈 \text{?} + \text{?} , w 〉 + D \text{?} ( w , w \text{?} ) \} , where g \text{?} ( j ) = 〈 \text{?} , \text{?} 〉 and \text{?} ( j ) =$ $4 \text{?} ( j ) {( g \text{?} ( j ) + h \text{?} ( j ) + β \text{?} )}^{2} for all j ∈ [ M ] .$ [symbol]
indicates data missing or illegible when filed
```

### (Processing of Algorithm 1)

First, processing of Algorithm 1 will be described. As described at the beginning of Algorithm 1, the acquisition unit 11 acquires the values of K, N, and η. Here, K is a first natural number that defines the total number of experts, and N is a second natural number that defines the total number of experts. As an example, each expert is specified two-dimensionally as (i, n) using two indexes i and n:

$$i ∈ [ K ] and n ∈ [ N ] . \qquad [ Math . 3 ]$$

The index n can also be regarded as an index for introducing and identifying each of so-called sleeping experts, but this does not limit the present exemplary example embodiment.

η is a parameter used to derive a weighting factor (wₜ(i, n) with tilde) to be referred to for deriving the first decision-making result (pₜ(i)) as described later.

Subsequently, as indicated in “1:” in Algorithm 1, the derivation unit 12 sets the reliability w₁ of each expert in the round 1 to 0.

Subsequently, the control unit 10A executes loop processing specified by “2:” to “12:” of Algorithm 1. The loop processing is executed until t=T (T is the total number of rounds) while incrementing the index t indicating the round. In other words, the control unit 10A repeats the processing specified in “3:” to “12:” of Algorithm 1 for each round.

More specifically, first, as indicated in “3:” of Algorithm 1, the acquisition unit 11 acquires the prediction value mₜ provided by each expert. Here, mₜ is acquired as a vector in which the number of elements is the above-described first natural number K as an example, as indicated in “3:” of Algorithm 1. In the present example, the prediction value mₜ can be interpreted as an estimated value (prediction value) regarding the loss lₜ, but the matter does not limit the present exemplary example embodiment.

Subsequently, as indicated in “4:” of Algorithm 1, the first derivation unit 121 uses:
the reliability wₜ(i, n) of each expert;
a prediction value mₜ(i) provided by each expert; and
parameter η,
to derive the weighting factor (wₜ(i, n) with tilde) by the following expression.

$${\tilde{w}}_{y} ( i , n ) ← exp ( - η ( {w}_{t} ( i , n ) + {m}_{t} ( i ) ) ) \qquad [ Math . 4 ]$$

Then, the first derivation unit 121 uses the weighting factor to derive the first decision-making result pₜ(i), as indicated in “5:” of Algorithm 1, by the following expression.

$${p}_{t} ( i ) ← \frac{{\sum }_{n ∈ [ N ]} {\tilde{w}}_{t} ( i , n )}{{\sum }_{i ∈ [ K ]} {\sum }_{n ∈ [ N ]} {\tilde{w}}_{t} ( i )} \qquad [ Math . 5 ]$$

In this manner, the first derivation unit 121 derives the first decision-making result (pₜ) in accordance with each prediction value (mₜ) acquired by the acquisition unit 11 and the reliability (wₜ) of each expert.

As expressed by the above expression, each of the first derivation units 121-1, 121-2, . . . calculates a weighting factor (wₜ(i, n) with tilde) determined by the reliability wₜ(i, n) and the prediction value mₜ(i) for each expert, and derives the first decision-making result (pₜ(i)) using the linear sum of the weighting factors.

As described above, since the first derivation unit 121 adopts the configuration that derives the first decision-making result (pₜ(i)) using the linear sum of weighting factors, in a case where the number of experts increases, a weighting factor regarding a new expert may be added to the linear sum, and in a case where the number of experts decreases, a weighting factor regarding the expert may be deleted from the linear sum.

Therefore, according to this configuration, it is possible to implement sequential decision-making processing that can flexibly cope with addition or deletion of an expert.

The derived first decision-making result pₜ is executed by the execution unit 21 of the terminal device 2A as an example as indicated in “6:” of Algorithm 1. Then, the loss value lₜ relevant to the first decision-making result pₜ is acquired by the loss value acquisition unit 22 of the terminal device 2A and provided to the information processing device 1A. At least a part of the derived first decision-making result pₜ may be supplied to the second derivation unit 122 that executes Algorithm 2 described later without being executed.

Δ_{K} indicated in “6:” of Algorithm 1 indicates a set defined by the following expression.

$${Δ}_{K} := \{ p ∈ {ℝ}^{K} \vert p ( i ) \geq 0 , {\sum }_{i ∈ [ K ]} p ( i ) = 1 \} \qquad [ Math . 6 ]$$

Subsequently, as indicated in “7:” of Algorithm 1, the acquisition unit 11 acquires a parameter αₜ for correcting the reliability wₜ.

Subsequently, loop processing specified by “8:” to “12:” of Algorithm 1 is executed. The loop processing is executed while incrementing an index n designating each expert.

As indicated in “9:” to “10:” of Algorithm 1, if the round number t satisfies the following condition that is expressed using a certain odd number d and an index n designating each expert:

$$t = d {2}^{n} ,$$

the first derivation unit 121 sets the reliability wₜ₊₁(i, n) of the expert (i, n) to 0. The processing indicated in “9:” to “10:” of Algorithm 1 can be expressed as an example of resetting the reliability wₙ of an n-th expert using a predetermined proportionality coefficient d (d is a natural number) and a constant term g (g is an integer) among a plurality of experts at timings (rounds) t indicated as follows:

$$t = d \times {2}^{n} + g .$$

As described above, in the present example, as indicated in “9:” to “10:” of Algorithm 1, the reliability of each of the plurality of experts is reset at different timings. Therefore, it is possible to suppress an increase in calculation cost while suppressing a decrease in accuracy of a decision-making result.

On the other hand, as indicated in “11:” to “12:” of Algorithm 1, if the above-described condition regarding the round number t is not satisfied, the first derivation unit 121 updates the reliability of each expert by the following expression.

$${w}_{t + 1} ( i , n ) ← {w}_{t} ( i , n ) + {ℓ}_{t} ( i ) - 〈 {ℓ}_{t} , {p}_{t} 〉 + 4 {η ( {ℓ}_{t} ( i ) - {m}_{t} ( i ) + {α}_{t} )}^{2} \qquad [ Math . 7 ]$$

Here, in the above expression, <, > represents an inner product.

As described above, the first derivation unit 121 updates the reliability (wₜ) regarding each expert with reference to each loss value (lₜ) acquired by the acquisition unit 11 (deriving wₜ₊₁).

As is clear from the above expression, the update of the reliability by the first derivation unit 121 is performed with reference to the correction parameter at acquired in “7:” of Algorithm 1. Therefore, the reliability of each expert can be suitably corrected by appropriately setting the correction parameter αₜ. For example, it is possible to perform processing of giving a predetermined or higher degree of reliability to an expert more reliable than other experts. Therefore, according to the above configuration, it is possible to perform operation with guaranteed minimum accuracy, that is, so-called conservative operation.

The correction parameter αₜ can be expressed as a parameter for correcting the reliability as described above, but as is clear from “12:” of Algorithm 1, the correction parameter at can also be regarded as a parameter for correcting the loss value lₜ(i) or a parameter for correcting the prediction value mₜ(i).

### (Processing of Algorithm 2)

Next, processing of Algorithm 2 will be described. As described at the beginning of Algorithm 2, the acquisition unit 11 acquires the values of K, N, and T. Here, K, N, and T have the same meanings as the relevant parameters in Algorithm 1. Specifically, K is a first natural number defining the total number of experts, N is a second natural number defining the total number of experts, and T is the total number of rounds.

As indicated by “Input” at the beginning of Algorithm 2, Algorithm 2 is executed with reference to a base Algorithm B. Here, the base Algorithm B refers to the above-described Algorithm 1 as an example. Algorithm 2 is executed with reference to a plurality of base Algorithms B. In other words, the second derivation unit 122 executes the second algorithm in cooperation with the first algorithm that executes each of the plurality of Algorithms 1. Algorithm 1 may be referred to as a base algorithm, and Algorithm 2 may be referred to as a master algorithm, but the name does not limit the present exemplary example embodiment.

Subsequently, as indicated in “1:” of Algorithm 2, the second derivation unit 122 sets the parameter M to the following expression using the total number T of rounds.

$$M = ⌈ {log}_{2} T ⌉ \qquad [ Math . 8 ]$$

Here, symbols on both sides of log₂T indicate ceiling functions. Therefore, the parameter M is set by the second derivation unit 122 to a minimum integer value equal to or larger than the argument (log₂T) that is a real number (for example, if log₂T=3.3 . . . , M=4 is set).

Here, the parameter M has a meaning as a total number of base algorithms (Algorithm 1) referred to by Algorithm 2, but this does not limit the present exemplary example embodiment.

As indicated in “1:” of Algorithm 2, the second derivation unit 122 sets η(j) to the following expression.

$$η ( j ) = {2}^{j - M / 2} \qquad [ Math . 9 ]$$

Here, the index j is an index for identifying a plurality of base algorithms from each other, and takes an integer value from 1 to M as an example, as indicated in “1:” of Algorithm 2.

Subsequently, as indicated in “2:” of Algorithm 2, the second derivation unit 122 sets a weighting factor w₁′ in the round t=1 such that a parameter p₁′ relevant to the decision-making result in the round 1 satisfies the following expression for each j.

$${p}_{1}^{′} ∝ {η ( j )}^{2} \qquad [ Math . 10 ]$$

Here, the weighting factor w₁′ in the round t=1 satisfies the following expression, as indicated in “2:” of Algorithm 2.

$${w}_{1}^{′} ∈ {Δ}_{M} \qquad [ Math . 11 ]$$

Here, Δ_{M} represents a set obtained by replacing K with M in Δ_{K} described above.

Subsequently, as indicated in “3:” of Algorithm 2, the second derivation unit 122 initializes each base algorithm as following.

$${\{ {ℬ}_{j} \}}_{j ∈ [ M ]} \qquad [ Math . 12 ]$$

Here, in the initialization processing, as indicated in “3:” of Algorithm 2, the second derivation unit 122 includes a process of passing each value of M, N, T, and η(j) for the base Algorithm Bⱼ.

Subsequently, the control unit 10A executes loop processing specified by “4:” to “13:” of Algorithm 2. The loop processing is executed until t=T while incrementing the index t indicating the round. In other words, the control unit 10A repeats the processing specified in “5:” to “13:” of Algorithm 1 for each round.

More specifically, first, as indicated in “5:” of Algorithm 2, the acquisition unit 11 acquires the prediction value mₜ, and the second derivation unit 122 supplies the prediction value mₜ to each base algorithm (each Algorithm 1) via each first derivation unit 121.

Subsequently, as indicated in “6:” of Algorithm 2, the acquisition unit 11 acquires a decision-making result p_{t,j} by each base algorithm (each Algorithm 1). Then, as indicated in “6:” of Algorithm 2, the second derivation unit 122 sets the parameter hₜ(j) by the following expression.

$${h}_{t} ( j ) = 〈 {m}_{t} , {p}_{t , j} 〉 \qquad [ Math . 13 ]$$

Here, <, > represents an inner product.

Subsequently, as indicated in “7:” of Algorithm 2, the second derivation unit 122 derives a reliability vector wₜ indicating the reliability of each base algorithm by the following expression.

$${w}_{t} ∈ arg {min}_{w ∈ {Δ}_{M}^{′} ( \frac{1}{MT} )} \{ 〈 {h}_{t} , w 〉 + {D}_{ψ} ( w , {w}_{t}^{′} ) \} \qquad [ Math . 14 ]$$

Here, D_{ψ} indicates a Bregman divergence defined by the following expression.

$${D}_{ψ} ( y , x ) := ψ ( y ) - ψ ( x ) - 〈 ∇ ψ ( x ) , y - x 〉 \qquad [ Math . 15 ]$$

ψ is defined by the following expression.

$$ψ ( w ) = {\sum }_{j ∈ [ M ]} \frac{1}{η ( j )} w ( j ) log w ( j ) \qquad [ Math . 16 ]$$

Subsequently, as indicated in “8:” of Algorithm 2, the second derivation unit 122 uses:
the decision-making result p_{t,j} by each base algorithm (each Algorithm 1); and
the reliability wₜ(j) that is each component of the reliability vector wₜ indicating the reliability of each base algorithm,
so as to calculate the second decision-making result pₜ by the following expression.

$${p}_{t} ← {\sum }_{j ∈ [ M ]} {w}_{t} ( j ) {p}_{t , j} \qquad [ Math . 17 ]$$

As described above, the second derivation unit 122 derives the second decision-making result pₜ according to the first decision-making result (p_{t,j}) derived by each of the plurality of first derivation units 122-j and the reliability (wₜ(j)) of each of the plurality of first derivation units 122-j.

More specifically, as expressed by the above expression, the second derivation unit 122 derives the second decision-making result pₜ by a weighted sum of the first decision-making results (p_{t,j}) derived by the plurality of first derivation units 121-j and relevant to the reliability (wₜ(j)) of each of the plurality of first derivation units 122-j.

As described above, the second derivation unit 122 derives the second decision-making result pₜ according to the first decision-making result (p_{t,j}) derived by each of the plurality of first derivation units 122-j and the reliability (wₜ(j)) of each of the plurality of first derivation units 122-j. Here, the first decision-making result is performed with reference to the prediction value provided by each expert as described above.

Therefore, according to the above configuration, a suitable decision-making result can be derived by the first derivation unit 121 and the second derivation unit 122 with reference to the prediction value provided by each expert.

Subsequently, as indicated in “9:” of Algorithm 2, the derived second decision-making result pₜ is executed by the execution unit 21 of the terminal device 2A as an example. Then, the loss value lₜ relevant to the second decision-making result pₜ is acquired by the loss value acquisition unit 22 of the terminal device 2A and provided to the information processing device 1A.

Subsequently, as indicated in “10:” of Algorithm 2, the acquisition unit 11 acquires the correction parameter αₜ.

Subsequently, as indicated in “11:” of Algorithm 2, the second derivation unit 122 supplies the loss value lₜ acquired by “9:” of Algorithm 2 and each component αₜ(j) of the correction parameter αₜ acquired by “10:” of Algorithm 2 to the base Algorithm Bj. The loss value lₜ provided in this step is relevant to, for example, lₜ obtained in “6:” of Algorithm 1. αₜ(j) provided in this step is relevant to the correction parameter αₜ acquired in “7:” of Algorithm 1.

Subsequently, as indicated in “12:” of Algorithm 2, the acquisition unit 11 acquires a correction parameter βₜ. Subsequently, as indicated in “13:” of Algorithm 2, the second derivation unit 122 updates the weighting factor wₜ′ in the round t to a weighting factor wₜ₊₁′ in the round t+1. More specifically, the second derivation unit 122 calculates the weighting factor wₜ₊₁′ in the round t+1 by the following expression.

$${w}_{t + 1}^{′} ∈ arg {min}_{w ∈ {Δ}_{M}^{′} ( \frac{1}{MT} )} \{ 〈 {g}_{t} + {b}_{t} , w 〉 + {D}_{ψ} ( w , {w}_{t}^{′} ) \} \qquad [ Math . 18 ]$$

Here, gₜ is defined by the following expression.

$${g}_{t} ( j ) = 〈 {ℓ}_{t} , {p}_{t , j} 〉 \qquad [ Math . 19 ]$$

bₜ is defined by the following expression.

$${b}_{t} ( j ) = 4 η ( j ) {( {g}_{t} ( j ) - {h}_{t} ( j ) + {β}_{t} )}^{2} \qquad [ Math . 20 ]$$

Δ_{K}′(α) is a set defined by the following expression.

$${Δ}_{K}^{′} ( α ) := \{ p ∈ {ℝ}^{K} \vert p ( i ) \geq α , {\sum }_{i ∈ [ K ]} p ( i ) = 1 \} \qquad [ Math . 21 ]$$

As described above, the second derivation unit 122 updates the weighting factor wₜ′ with reference to the loss value lₜ and p_{t,j} of each of the plurality of first decision-making results, and the updated weighting factor is referred to for deriving the reliability wₜ₊₁ in the next round. Therefore, according to the above configuration, it is possible to derive a decision-making result suitably adapted to a changeable environment.

As described above, the weighting factor wₜ′ is updated by the second derivation unit 122 with reference to the correction parameter βₜ, as indicated in “13:” of Algorithm 2. Therefore, the reliability of each of the plurality of first derivation units 122-j (in other words, a plurality of base algorithms) can be suitably corrected by appropriately setting the correction parameter βₜ. For example, it is possible to perform processing of giving a predetermined or more reliability to a base algorithm that is more reliable than other base algorithms. Therefore, according to the above configuration, it is possible to perform operation with guaranteed minimum accuracy, that is, so-called conservative operation.

The correction parameter βₜ can also be expressed as a parameter for correcting the reliability, but as is clear from “13:” of Algorithm 2, the correction parameter βₜ can also be regarded as a parameter for correcting the loss value lₜ or a parameter for correcting the first decision-making result p_{t,j}.

As described above, according to the first derivation unit 121 and the second derivation unit 122 that execute Algorithm 1 and Algorithm 2, in each of the plurality of Algorithms 1 (base algorithms), the reliability of each of the plurality of experts constituting at least a part of the plurality of experts is reset at different timings. Then, the second decision-making result is derived with reference to the first decision-making result by such Algorithm 1 (base algorithm). Therefore, according to the above configuration, it is possible to derive a suitable decision-making result while suppressing an increase in calculation cost.

### (Another Example of Base Algorithm)

The base algorithm executed by the first derivation unit 121 is not limited to Algorithm 1 described above. Hereinafter, Algorithm 1′, which is another example of the base algorithm, will be described. Algorithm 1′ is mainly executed by each of the plurality of first derivation units 121-1, 121-2, . . . . The second derivation unit 122 executes the above-described Algorithm 2 in cooperation with the plurality of first derivation units 121 that execute Algorithm 1′. Algorithm 2 has been described above, and thus description thereof will be omitted.

MATH 22
Algorithm 1′

```
Input: K ∈ [symbol] , N ∈ [symbol]   and η ∈ [symbol]   s.t. η > 0.
  1: w₁ ← 0_{K×N}.
  2: for t = 1, 2, ... , T do
  3: Receive prediction mₜ ∈ [symbol] ^{K}.
  4: [symbol]  (i, n) ← exp (−η(wₜ(i, n) + mₜ(i))) for all i ∈ [K] and n ∈ [N].
  5:  $p \text{?} ( i ) ← \frac{\text{?}}{\text{?}} for all i ∈ [ K ] .$
  6: Play pₜ ∈ Δ_{K} and observe [symbol]  ₜ ∈ [symbol] ^{K}.
  7: Receive αₜ, ∈ [symbol]  .
  8: for n ∈ [N] do
  9: if t = dN + n for some integer d then
10: wₜ₊₁(i, n) ← 0 for all i ∈ [K].
11: else
12: wₜ₊₁(i, n) ← wₜ(i, n) + [symbol] ₜ(i) − [symbol] [symbol]    ₜ, pₜ [symbol]  + 4η( [symbol]  ₜ(i) − mₜ(i) + αₜ)² for all i ∈ [K]. [symbol]
indicates data missing or illegible when filed
```

Algorithm 1′ differs from Algorithm 1 in “9:”, and the other parts are similar to Algorithm 1.

In Algorithm 1′, as indicated in “9:” of Algorithm 1′, if the condition,

$$t = dN + n ,$$

is satisfied in which the round number t is expressed using a certain odd number d, an index n designating each expert, and the second natural number N that defines the total number of experts, the first derivation unit 121 sets the reliability wₜ+1(i, n) of the expert (i, n) to 0. The processing indicated in “9:” to “10:” of Algorithm 1′ can be expressed as an example of resetting the reliability wₙ of an n-th expert using a predetermined proportionality coefficient d (d is a natural number) and a constant term g (g is an integer) among a plurality of experts at timings (rounds) t indicated as follows:

$$t = d \times N + n + g .$$

As described above, in the present example, also in Algorithm 1′, as indicated in “9:” to “10:” of Algorithm 1′, the reliability of each of the plurality of experts is reset at different timings. Therefore, it is possible to suppress an increase in calculation cost while suppressing a decrease in accuracy of a decision-making result.

### Application Example

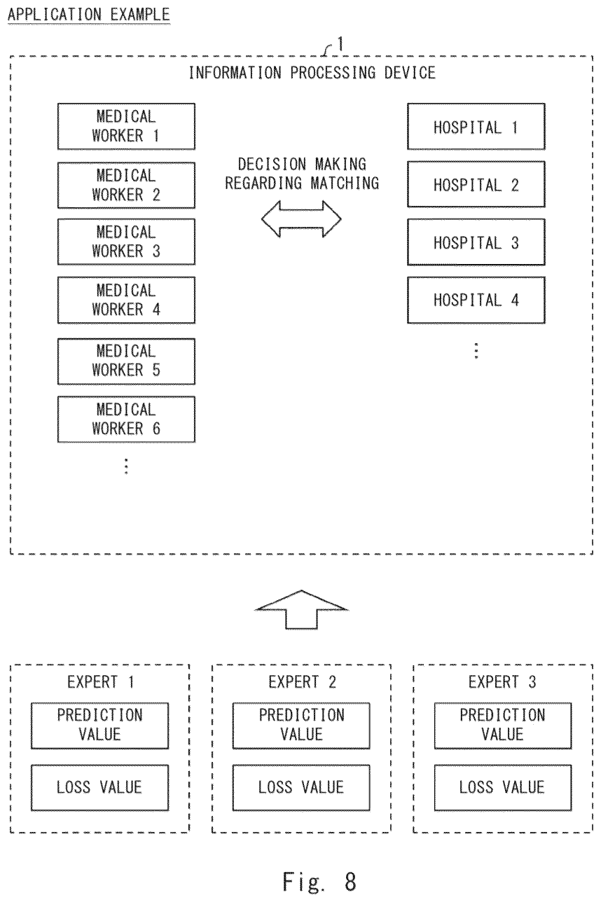

Hereinafter, an application example in which the information processing system 100 according to the present exemplary example embodiment is applied to medical care and healthcare will be described. FIG. 8 is a diagram schematically illustrating processing by the information processing device 1 according to the present example.

As illustrated in FIG. 8, the information processing device 1 according to the present example makes a decision regarding matching between a plurality of medical workers and a plurality of hospitals (deriving a decision-making result). Here, as described above, the information processing device 1 according to the present example acquires a prediction value and a loss value associated with each expert for a plurality of experts in a certain round, and derives a decision-making result with reference to each acquired prediction value and each acquired loss value.

Although the specific configuration of the information processing device 1 according to the present example does not limit the present application example, it may have a configuration similar to that of the information processing device 1 described in the first exemplary example embodiment, or may have a configuration similar to that of the information processing device TA described in the second exemplary example embodiment.

The decision-making processing performed by the information processing device 1 according to the present example can be hierarchical decision-making processing by the plurality of first derivation units 12-1, 121-2, . . . , and the second derivation unit 122 as described with respect to the information processing device TA as an example, but this does not limit the present application example.

Then, a loss value relevant to the next round is obtained by executing the derived decision-making result. The loss value and the prediction value relevant to the loss value are provided to the information processing device 1 according to the present example, and are referred to in the decision-making processing in the next round.

The input to each expert and the output (prediction value) of each expert according to the present example are as follows. As described in the first exemplary example embodiment, the information processing system according to the present example may be configured to include an “expert” or may be configured to acquire a prediction value from an external “expert”.

### (Example of Input to Expert)

Feature amounts of each hospital and each medical worker observed at time t (round t)
Number of patients who visited each hospital in previous round (round t−1)

### (Example of Output of Expert)

Assigned hospital for each medical worker at time t (round t).
   (Flow of Processing according to Present Example)

An example of processing by the information processing system 100 according to the present example will be described below.

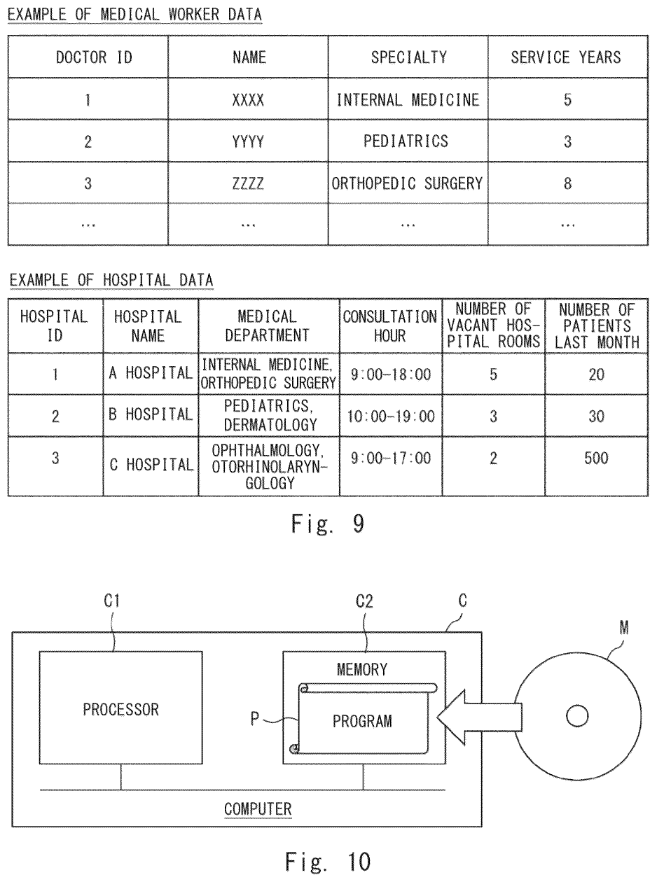

First, a person in charge of inputting in a hospital inputs information (also referred to as hospital data) such as a diagnosis status, availability of a hospital room, a medical department, and a consultation hour to the information processing system 100 via the terminal device 2A or the like. Each piece of input information is stored in the storage unit 15A as an example, and is referred to by the control unit 10A. The lower part of FIG. 9 is an example of hospital data managed by the information processing system 100 according to the present example.

Subsequently, each medical worker inputs his/her data (specialty, service years, desired hospital, etc.) (also, referred to as medical worker data) to the information processing system 100. Each piece of input information is stored in the storage unit 15A as an example, and is referred to by the control unit 10A. The upper part of FIG. 9 is an example of medical worker data managed by the information processing system 100 according to the present example.

Subsequently, the information processing device 1 according to the present example derives a decision-making result regarding matching between an optimal hospital and the medical worker with reference to the hospital data and the data of the medical worker. As an example, each of the plurality of experts according to the present example calculates the prediction value with reference to the hospital data and the medical worker data. Then, the information processing device 1 according to the present example refers to these prediction values, and the information processing device 1 according to the present example derives a decision-making result regarding matching between an optimal hospital and a medical worker.

Then, the information processing system 100 according to the present example proposes an optimal candidate for a hospital to a medical worker via the terminal device 2A or the like. As an example, the information processing system 100 according to the present example presents an optimal candidate for a hospital to a medical worker via a display panel or the like included in the terminal device 2A. The information processing system 100 according to the present example performs registration regarding work for each medical worker.

As an example, the information processing system 100 according to the present example records the number of patients visiting each hospital every month (every round). Then, the information processing system 100 according to the present example determines an assignment destination in the next (next round) based on the loss value regarding the number of visiting patients.

Here, a specific example of the loss value is not limited to this example, but as an example, a loss value relevant to the degree of congestion in a hospital can be used.

More specifically, the loss value may be configured to calculate the loss value by (Actual number of patients who visited each hospital)−(Number of medical worker assigned to each hospital×Number of patients that can be examined by medical worker per person)

If referring to the prediction value by each expert or each first decision-making result, the information processing device 1 according to the present example may adopt the prediction value by each expert or each first decision-making result with a probability relevant to the reliability instead of using the weighted sum of these values relevant to the reliability.

As described above, the information processing system described in the present specification can suitably make a decision regarding matching between a plurality of medical workers and a plurality of hospitals as an example. Of course, the application example by the information processing system described in the present specification is not limited to the above example. It can be applied to various cases regarding decision making (prediction).

### [Example of Implementation by Software]

The control blocks (in particular, the acquisition unit 11 and the derivation unit 12) of the information processing devices 1 and TA and the terminal devices 2 and 2A may be implemented by a logic circuit (hardware) formed in an integrated circuit (IC chip) or the like, or may be implemented by software.

In the latter case, the information processing devices 1 and TA and the terminal devices 2 and 2A include a computer that executes a command of a program that is software for achieving each function. The computer includes, for example, at least one processor (control device) and at least one computer-readable recording medium storing the program. Then, in the computer, the processor reads the program from the recording medium and executes the program, whereby the object of the present invention is achieved.

As the above-described processor, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination of these can be used.

As the recording medium, a “non-transitory tangible medium”, for example, a tape, a disk, a card, a semiconductor memory, a programmable logic circuit, and the like can be used in addition to a read only memory (ROM) and the like. A random access memory (RAM) or the like for expanding the program may be further provided. The program may be supplied to the computer via an arbitrary transmission medium (communication network, broadcast wave, or the like) capable of transmitting the program. One aspect of the present invention can also be achieved in a form of a data signal embedded in a carrier wave in which the program is embodied by electronic transmission.

### [Supplementary Information 1]

The present invention is not limited to the above-described example embodiments, and various changes can be made without departing from the spirit and the scope as defined by the claims. For example, example embodiments obtained by appropriately combining the technical means disclosed in the above-described example embodiments are also included in the technical scope of the present invention.

### [Supplementary Information 2]

Some or all the above-described example embodiments may be described as follows. However, the present invention is not limited to the following aspects.

### (Supplementary Note 1)

An information processing device including:
an acquisition means for acquiring a prediction value (output value) obtained from each of a plurality of experts (models) and a loss value relevant to each prediction value (output value);
a derivation means (derivation unit 12) for deriving a decision-making result (optimal solution) according to each prediction value (output value) acquired by the acquisition means and a reliability of each expert (model); and
an update means (derivation unit 12) for updating the reliability of each expert with reference to each loss value acquired by the acquisition means,
in which the update means resets (initializes) the reliability of each of a plurality of experts (models) constituting at least a part of the plurality of experts (models) at timings different from each other.

### (Supplementary Note 2)

The information processing device according to Supplementary Note 1, in which the derivation means derives the decision-making result (optimal solution) with further reference to a parameter for correcting the reliability.

### (Supplementary Note 3)

The information processing device according to Supplementary Note 1 or 2, in which the update means (derivation unit 12) resets (initializes) a reliability wₙ of an n-th expert (model) among the plurality of experts (models) using a predetermined proportionality coefficient d and a constant term g at timings t indicated as follows:

$$t = d \times {2}^{n} + g .$$

### (Supplementary Note 4)

The information processing device according to Supplementary Note 1 or 2, in which the update means (derivation unit 12) resets (initializes) a reliability wₙ of an n-th expert (model) among the plurality of experts (models) using a total number N of experts (models) and predetermined constants d and g at timings t indicated as follows:

$$t = d \times N + n + g .$$

### (Supplementary Note 5)

The information processing device according to any one of Supplementary Notes 1 to 4, in which the derivation means includes:
a plurality of first derivation means for deriving a first decision-making result (first optimal solution) according to each prediction value (output value) acquired by the acquisition means and a reliability of each expert (model); and
a second derivation means for deriving a second decision-making result (second optimal solution) according to the first decision-making result (first optimal solution) derived by each of the plurality of first derivation means and a reliability of each of the plurality of first derivation means.

### (Supplementary Note 6)

The information processing device according to Supplementary Note 5, in which the first derivation means is configured to execute: calculating a weighting factor determined by the reliability and the prediction value (output value) for each expert (model), and deriving a first decision-making result (first optimal solution) using a linear sum of the weighting factors.

### (Supplementary Note 7)

The information processing device according to Supplementary Note 5 or 6, in which the second derivation means is configured to execute: deriving the second decision-making result (second optimal solution) by a weighted sum of the first decision-making results (first optimal solutions) derived by the plurality of first derivation means, the weighted sum being relevant to the reliability of each of the plurality of first derivation means.

### (Supplementary Note 8)

An information processing method for causing an information processing device to execute:
acquiring a prediction value (output value) obtained from each of a plurality of experts (models) and a loss value relevant to each prediction value (output value); and
deriving a decision-making result (optimal solution) according to the acquired each prediction value (output value) and the reliability of each expert (model), and updating the reliability of each expert (model) with reference to the acquired each loss value,
in which in the updating, the reliability of each of a plurality of experts (models) constituting at least a part of the plurality of experts (models) is reset (initialized) at different timings.

### (Supplementary Note 9)

A program for causing a computer to function as an information processing device, the program causing the computer to execute:
acquiring a prediction value (output value) obtained from each of a plurality of experts (models) and a loss value relevant to each prediction value (output value);
deriving a decision-making result (optimal solution) according to the acquired each prediction value (output value) and a reliability of each expert (model); and
updating the reliability of each expert (model) with reference to the acquired each loss value,
in which in the updating, the reliability of each of a plurality of experts (models) constituting at least a part of the plurality of experts (models) is reset (initialized) at different timings.

### (Supplementary Note 10)

An information processing system including:
an information processing device; and
a terminal device, in which
the information processing device includes:
an acquisition means for acquiring a prediction value (output value) obtained from each of a plurality of experts (models) and a loss value relevant to each prediction value (output value);
a derivation means for deriving a decision-making result (optimal solution) according to each prediction value (output value) acquired by the acquisition means and a reliability of each expert (model); and
an update means for updating the reliability of each expert (model) with reference to each loss value acquired by the acquisition means,
the update means initializes a reliability of each of a plurality of experts (models) constituting at least a part of the plurality of experts (models) at different timings, and
the terminal device includes:
an execution means for executing a decision-making result (optimal solution) derived by the information processing device; and
a loss value acquisition means for acquiring a loss value obtained by executing the decision-making result (optimal solution).

### [Supplementary Information 3]

Some or all the above-described example embodiments may be further described as follows.

### (Supplementary Note A1)

An information processing device including:
at least one processor, in which
the processor executes:
an acquisition process of acquiring an output value obtained from each of a plurality of models and a loss value relevant to each output value;
a derivation process of deriving an optimal solution according to each output value acquired by the acquisition process and a reliability of each model; and
an update process of updating the reliability of each model with reference to each loss value acquired by the acquisition process,
the update process initializes the reliability of each of a plurality of models constituting at least a part of the plurality of models at different timings.

### (Supplementary Note A2)

The information processing device according to Supplementary Note A1, in which the processor derives, in the derivation process, the optimal solution with further reference to a parameter for correcting a reliability.

### (Supplementary Note A3)

The information processing device according to Supplementary Note A1 or A2, in which the processor initializes, in the update process, a reliability wₙ of an n-th model among the plurality of models using a predetermined proportionality coefficient d and a constant term g at timings t indicated as follows:

$$t = d \times {2}^{n} + g .$$

### (Supplementary Note A4)

The information processing device according to Supplementary Note A1 or A2, in which the processor initializes, in the update process, a reliability wₙ of an n-th model among the plurality of models using a total number N of models and predetermined constants d and g at timings t indicated as follows:

$$t = d \times N + n + g .$$

### (Supplementary Note A5)

The information processing device according to any one of Supplementary Notes A1 to A4, in which the derivation process includes:
a plurality of first derivation processes for deriving a first optimal solution according to each output value acquired by the acquisition process and a reliability of each model; and
a second derivation process for deriving a second optimal solution according to a first optimal solution derived by each of the plurality of first derivation processes and a reliability of each of the plurality of first derivation processes.

### (Supplementary Note A6)

The information processing device according to Supplementary Note A5, in which the processor is configured to execute, in the first derivation process: calculating a weighting factor determined by the reliability and the output value for each model, and deriving a first optimal solution using a linear sum of the weighting factors.

### (Supplementary Note A7)

The information processing device according to Supplementary Note A5 or A6, in which the processor is configured to execute, in the second derivation process: deriving the second optimal solution by a weighted sum of the first optimal solutions derived by the plurality of first derivation processes, the weighted sum being relevant to the reliability of each of the plurality of first derivation processes.

### (Supplementary Note A8)

An information processing method for causing an information processing device to execute:
acquiring an output value obtained from each of a plurality of models and a loss value relevant to each output value;
deriving an optimal solution according to the acquired each output value and a reliability of each model; and
updating the reliability of each model with reference to the acquired each loss value,
in which in the updating, the reliability of each of a plurality of models constituting at least a part of the plurality of models is initialized at different timings.

### (Supplementary Note A9)

A non-transitory recording medium having stored therein a program for causing a computer to function as an information processing device, the program causing the computer to execute:
acquiring an output value obtained from each of a plurality of models and a loss value relevant to each output value;
deriving an optimal solution according to the acquired each output value and a reliability of each model; and
updating the reliability of each model with reference to the acquired each loss value,
in which in the updating, the reliability of each of a plurality of models constituting at least a part of the plurality of models is initialized at different timings.

### (Supplementary Note A10)

An information processing system including:
an information processing device; and
a terminal device, in which
the information processing device includes one or a plurality of first processors,
the first processor is configured to execute:
an acquisition process of acquiring an output value obtained from each of a plurality of models and a loss value relevant to each output value;
a derivation process of deriving an optimal solution according to each output value acquired by the acquisition process and a reliability of each model; and
an update process of updating the reliability of each model with reference to each loss value acquired by the acquisition process,
in the update process, a reliability of each of a plurality of models constituting at least a part of the plurality of models is initialized at different timings, and
the terminal device includes one or a plurality of second processors,
the second processor is configured to execute:
an execution process of executing an optimal solution derived by the information processing device; and
a loss value acquisition process of acquiring a loss value obtained by executing the optimal solution.

The information processing device and the information processing system described above may further include a memory, and the memory may store a program for causing the processor to execute the acquisition process, the derivation process, and the update process. This program may be recorded in a non-transitory tangible computer-readable recording medium.

### REFERENCE SIGNS LIST

1, 1A information processing device
100, 100A information processing system
10A control unit
11 acquisition unit
12 derivation unit
121 first derivation unit
122 second derivation unit
S1, S100 information processing method

What is claimed is:

1. An information processing device comprising:
at least one memory that is configured to store instructions; and
at least one processor that is configured to execute the instructions to:
acquire an output value obtained from each of a plurality of models and a loss value relevant to each output value;
derive an optimal solution according to each output value acquired by the acquisition means and a reliability of each model; and
update the reliability of each model with reference to each loss value acquired,
wherein the update means initializes the reliability of each of a plurality of models constituting at least a part of the plurality of models at different timings.

2. The information processing device according to claim 1, wherein the at least one processor that is configured to execute the instructions to derive the optimal solution with further reference to a parameter for correcting a reliability.

3. The information processing device according to claim 1, wherein the at least one processor that is configured to execute the instructions to initialize a reliability wₙ of an n-th model among the plurality of models using a predetermined proportionality coefficient d and a constant term g at timings t indicated as follows:
$$t = d \times {2}^{n} + g .$$

4. The information processing device according to claim 1, wherein the at least one processor that is configured to execute the instructions to initialize a reliability wₙ of an n-th model among the plurality of models using a total number N of models and predetermined constants d and g at timings t indicated as follows:
$$t = d \times N + n + g .$$

5. The information processing device according to claim 1, wherein the at least one processor that is configured to execute the instructions to:
a plurality of first derivation units configured to derive a first optimal solution according to each prediction value acquired by the acquisition units and a reliability of each model; and
a second derivation unit configured to derive a second optimal solution according to a first optimal solution derived by each of the plurality of first derivation units and a reliability of each of the plurality of first derivation units.

6. The information processing device according to claim 5, wherein the first derivation unit is configured to execute: calculating a weighting factor determined by the reliability and the output value for each model, and deriving a first optimal solution using a linear sum of the weighting factors.

7. The information processing device according to claim 5, wherein the second derivation unit is configured to execute: deriving the second optimal solution by a weighted sum of the first optimal solutions derived by the plurality of first derivation units, the weighted sum being relevant to the reliability of each of the plurality of first derivation units.

8. An information processing method for causing an information processing device to execute:
acquiring an output value obtained from each of a plurality of models and a loss value relevant to each output value;
deriving an optimal solution according to the acquired each output value and a reliability of each model; and
updating the reliability of each model with reference to the acquired each loss value,
wherein in the updating, the reliability of each of a plurality of models constituting at least a part of the plurality of models is initialized at different timings.

9. A non-transitory computer-readable medium storing a program for causing a computer to function as an information processing device, the program causing the computer to execute:
acquiring an output value obtained from each of a plurality of models and a loss value relevant to each output value;
deriving an optimal solution according to the acquired each output value and a reliability of each model; and
updating the reliability of each model with reference to the acquired each loss value,
wherein in the updating, the reliability of each of a plurality of models constituting at least a part of the plurality of models is initialized at different timings.

10. (canceled)
